(19) United States
(12) Patent Application Publication
(10) Pub. No.: US 2013/0242560 A1
(43) Pub. Date: Sep. 19, 2013

(54) LED STRING LIGHT MADE VIA SMD MANUFACTURING PROCESS

(71) Applicant: Yu-Mou HSU, Hsinchu City (TW)

(72) Inventor: Yu-Mou HSU, Hsinchu City (TW)

(21) Appl. No.: 13/554,806

(22) Filed: Jul. 20, 2012

(30) Foreign Application Priority Data
Mar. 16, 2012 (CN) 201220103673.6

(51) Int. Cl. F21S 4/00

(52) U.S. Cl. 362/249.06

(57) ABSTRACT

A LED string light made via SMD manufacturing process includes a first conductive wire and a second conductive wire that have respectively a plurality of first and second coupling sections spaced from each other at a selected interval. Each LED is connected to the first and second conductive wires in a juxtaposed manner via a SMD manufacturing process. Each LED has a cathode lead and an anode lead that are respectively connected to the first conductive wire and second conductive wire so that multiple sets of LEDs are juxtaposed onto the first and second conductive wires to form a serial LED string light which is sturdier than the conventional single string LED light.

### FIELD OF THE INVENTION

The present invention relates to a LED string light, and particularly to a sturdier dual-wire LED string light.

### BACKGROUND OF THE INVENTION

A conventional incandescent light bulb employs a tungsten filament as the light source. It's simpler in structure and easier for installation and replacement. It usually has a spherical shell with a tail end attached to an adapter which contains screw threads fastenable into a socket. When energized by electricity the tungsten filament in the shell is heated and generates light to pass through the shell to produce illumination as desired. When the incandescent light bulb generates light a great amount of heat also is produced. It consumes a lot of electric power and wastes energy. The tungsten filament also is easily burnt out and results in a shorter lifespan of the incandescent light bulb.

Light emitting diode (LED) is a solid state light source that transforms electric energy to light energy. It is made via epitaxy growing technique and semiconductor manufacturing technology. The LED provides many characteristics, such as smaller size, lower drive voltage, faster response rime, vibration resistance, longer life span and eco-friendly. With constant developments and advances of technology, its light generation efficiency also improves continuously since its first appearance in the market in 1960s. Now its light generation efficiency not only surpasses the tungsten light bulb (about 10-201 m/W), also outperforms the fluorescent lamp (about 60-801 m/W). Due to continuous progress of the LED related technology, it is predicted that it can reach 1001 m/W in a few years. As LED has become the most focused new generation of the solid state light source, and demand of smaller and lighter electronic elements is stronger, LED lamp sets adopted a light bulb profile have become increasingly popular and widely accepted. These days LED lighting fixtures have been commonly used on signal lights, street lights, household illumination lamps, vehicle lights, commercial lights and the like. They have become the mainstream in the lighting market.

At present the LED string light on the market can be divided into two types: First, a dual-wire LED string light in a parallel fashion, such as U.S. Pat. No. 7,235,815, which includes at least one LED chip and two conductive wires that have a holder at a selected interval to hold the LED chip. The LED chip is connected to the two conductive wires through two metal wires. Finally, the LED chip, holder and two metal wires are packaged in a transparent plastic capsule via injection to form a LED string light. Its fabrication process is complex. Moreover, the LED chip has to undergo a wire bonding process to form electric connection with the two conductive wires, and a transparent plastic capsule has to be provided at a selected interval on the two conductive wires to protect the metal wires and LED chip. As a result, the parallel dual-wire LED string light has the disadvantages of higher production cost and complex fabrication process.

To overcome the shortcomings of the parallel dual-wire LED string light, the present market mostly adopts the second type, namely a single wire LED string light in series, as shown in FIG. 1. It is easier to fabricate, but the electric contact between the LED lamp and conductive wire is smaller. The string light has two ends easily pulled by external forces and result in separation of the LED lamp and conductive wires and damage of the string light.

### SUMMARY OF THE INVENTION

The primary object of the present invention is to solve the problem of the conventional single wire LED string light by providing a dual-wire LED string light made via a surface mount device (SMD) manufacturing process to enhance the strength of the string light.

To achieve the foregoing object the LED string light of the invention includes a first conductive wire and a second conductive wire laid in a juxtaposed manner. The first and second conductive wires have respectively a plurality first and second coupling sections. The first coupling sections of the first conductive wire are spaced from each other at a first interval. Each second coupling section of the second conductive wire is positioned corresponding to the first interval in a juxtaposed manner, and formed at a length greater than the first interval and has two ends each having a second electric contact corresponding to two neighboring first coupling sections of the first conductive wire. Two neighboring second coupling sections of the second conductive wire also are spaced from each other at a second interval corresponding to one first coupling section which also has two ends each having a first electric contact corresponding to two neighboring second coupling sections. The invention also includes a plurality of LEDs each is connected to the first and second conductive wires in a juxtaposed manner via a SMD manufacturing process. The LED has a cathode lead connected to the first electric contact of the first coupling section and an anode lead connected to the second electric contact of the second coupling section. The cathode lead of the neighboring LED is connected to the second electric contact at the other end of the same second coupling section, and the anode lead is connected to the first electric contact of another neighboring first coupling section, thereby the LEDs are juxtaposed onto the first and second conductive wires to form a serial LED string light.

In short, the invention provides a LED string light by juxtaposing a plurality of LEDs onto the first and second conductive wires in series. Compared with the conventional serial LED string light with a single wire, the light string of the invention is sturdier and does not break away or damage easily.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional single wire LED string light.

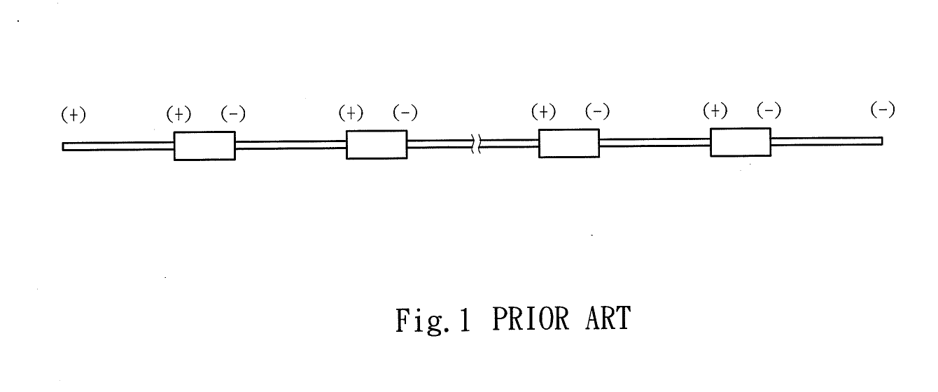

FIG. 2 is a schematic view of LED string light made via SMD manufacturing process according to the invention.

### DETAILED DESCRIPTION OF THE PREFERRED EMBODIMENT

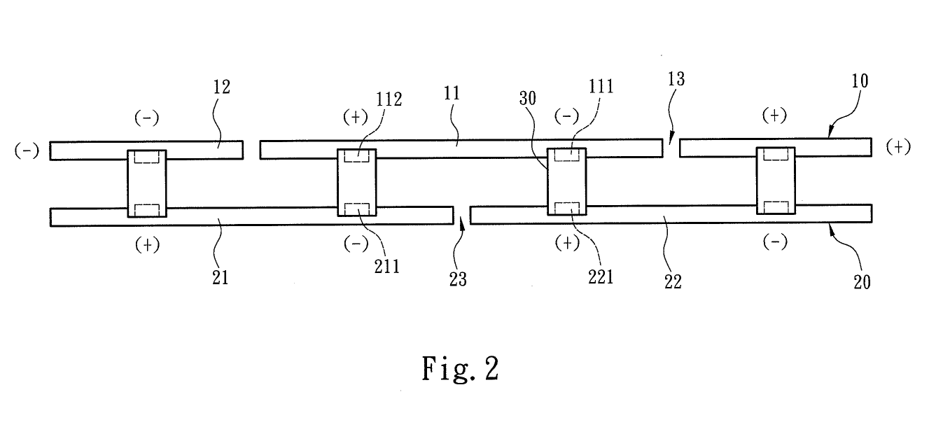

Please referring to FIG. 2, the present invention aims to provide a LED string light made via a SMD manufacturing process. The LED string light includes a first conductive wire 10, a second conductive wire 20 and a plurality of LEDs 30 that are coupled in series with enhanced connection strength. The first and second conductive wires 10 and 20 are laid in a juxtaposed manner, and have respectively a plurality of first coupling sections 11 and 12, and second coupling sections 21 and 22. The neighboring first coupling sections 11 and 12 are spaced from each other at a first interval 13. The neighboring second coupling sections 21 and 22 are spaced from each other at a second interval 23. The first coupling sections 11 and 12 correspond to the second interval 23 in a juxtaposed manner. The second coupling sections 21 and 22 correspond to the first interval 13 in a juxtaposed manner. The first coupling sections 11 and 12 are formed at a length greater than the second interval 23 and each has two ends corresponding to the neighboring second coupling sections 21 and 22 with at least one first electric contact 111 and 112 formed thereon. The second coupling sections 21 and 22 also are formed at a length greater than the first interval 13 and each has two ends corresponding to the neighboring first coupling sections 11 and 12 with at least one second electric contact 211 and 221 formed thereon. Each LED 30 is located on the first and second conductive wires 10 and 20 in a juxtaposed manner via a SMD manufacturing process. The LED 30 has a cathode lead connected to the first electric contact 111 of one first coupling section 11, and an anode lead connected to the second electric contact 221 of one corresponding second coupling section 22. The anode lead of the neighboring and juxtaposed LED 30 is connected to the first electric contact 112 at the other end of the same first coupling section 11, and the cathode lead thereof is connected to the other second electric contact 211 of the neighboring second coupling section 21. As shown in the drawing, the LEDs 30 are coupled to the first and second conductive wires 10 and 20 to form a serial LED string light. Compared with a single wire LED light string coupled in series, the LED string light provided by the invention is sturdier and less likely to break away or be damaged.

While the preferred embodiment of the invention has been set forth for the purpose of disclosure, it is not the limitation of the invention, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A LED string light made via surface mount device (SMD) manufacturing process, comprising:
a first conductive wire and a second conductive wire laid in a juxtaposed manner, the first and second conductive wires respectively including a plurality of first coupling sections and second coupling sections, two neighboring first coupling sections of the plurality of first coupling sections being spaced from each other at a first interval which corresponds to each of the plurality of second coupling sections in a juxtaposed manner, each of the plurality of second coupling sections being formed at a length greater than the first interval and including two ends each containing at least one second electric contact corresponding to each of the two neighboring first coupling sections of the first conductive wire, two neighboring second coupling sections of the plurality of second coupling sections being spaced from each other at a second interval which corresponds to each of the plurality of first coupling sections, each of the plurality of first coupling sections including two ends each containing at least one first electric contact corresponding to each of the two neighboring second coupling sections; and
a plurality of LEDs each being connected to the first conductive wire and the second conductive wire via a SMD manufacturing process, one of the plurality of LEDs containing a cathode lead connected to the at least one first electric contact of one of the plurality of first coupling sections and an anode lead connected to the at least one second electric contact of one of the plurality of second coupling sections, an anode lead of a neighboring one of the plurality of LEDs being connected to the at least one first electric contact at other end of the one of the plurality of first coupling section and the cathode lead thereof being connected to the at least one second electric contact of a neighboring one of the plurality of second coupling sections thereby the LEDs are juxtaposed onto the first conductive wire and the second conductive wire to form a serial LED string light.
